(19) United States
(12) Patent Application Publication
(10) Pub. No.: US 2024/0236910 A1
(43) Pub. Date: Jul. 11, 2024

(54) METHOD OF FIRST ACCESS AND MOBILITY MANAGEMENT FUNCTION (AMF) APPARATUS, METHOD OF USER EQUIPMENT (UE), FIRST ACCESS AND MOBILITY MANAGEMENT FUNCTION (AMF) APPARATUS, AND USER EQUIPMENT (UE)

(71) Applicant: NEC Corporation, Minato-ku, Tokyo (JP)

(72) Inventors: Kundan Tiwari, Tokyo (JP); Toshiyuki Tamura, Tokyo (JP); lskren lanev, Tokyo (JP)

(73) Assignee: NEC Corporation, Minato-ku, Tokyo (JP)

(21) Appl. No.: 18/571,954

(22) PCT Filed: Jun. 15, 2022
(86) PCT No.: PCT/JP2022/024008

§ 371 Date: Dec. 19, 2023

(30) Foreign Application Priority Data
Jun. 25, 2021 (IN) 202111028660

(51) Int. Cl. H04W 60/04; H04W 48/14; H04W 76/20

(52) U.S. Cl. CPC H04W 60/04; H04W 48/14; H04W 76/20

(57) ABSTRACT

[Problem]

This disclosure defines a Registration procedure with AMF re-allocation procedure when the UE is in CM-CONNECTED state.

[Solution]

A method of a first Access and Mobility Management Function (AMF) apparatus includes receiving, from a Radio Access Network (RAN), a Registration Request message of a User Equipment (UE) in CM-CONNECTED state. And the method includes sending the Registration Request message to a second AMF apparatus directly.

### TECHNICAL FIELD

This present disclosure relates to a method of a first Access and Mobility Management Function (AMF) apparatus, a method of a User Equipment (UE), a first Access and Mobility Management Function (AMF) apparatus, and a User Equipment (UE).

### BACKGROUND ART

According to the Registration with AMF re-allocation procedure defined in NPL 3, the initial UE message from the UE is transferred from an initial AMF to a target AMF either directly or via a RAN.

### CITATION LIST

### Non Patent Literature

[NPL 1] 3GPP TR 21.905: “Vocabulary for 3GPP Specifications”. V17.0.0 (2020-07)
[NPL 2] 3GPP TS 23.501: “System architecture for the 5G System (5GS)”. V17.0.0 (2021-03)
[NPL 3] 3GPP TS 23.502: “Procedures for the 5G System (5GS)”. V17.0.0 (2021-03)
[NPL 4] 3GPP TS 38.413: “NG-RAN; NG Application Protocol (NGAP)”. V16.5.0 (2021-04)

### SUMMARY OF INVENTION

### Technical Problem

However, it is not clear in current 3GPP specifications how a non-initial UE message can be transferred from the initial AMF to the target AMF when the initial AMF decided to re-allocate AMF for the UE.

That is, there is no 3GPP specification which defines how a non-initial UE message can be transferred from the initial AMF to the target AMF when the initial AMF decided to re-allocate the AMF for the UE. Due to the lack of procedure defined in 3GPP specifications, some of the Registration Management procedure does not work and leads to service degradation for the mobile users.

### Solution to Problem

In an aspect of the present disclosure, a method of a first Access and Mobility Management Function (AMF) apparatus includes receiving, from a Radio Access Network (RAN), a Registration Request message of a User Equipment (UE) in CM-CONNECTED state. And the method includes sending the Registration Request message to a second AMF apparatus directly.

In an aspect of the present disclosure, a method of a first Access and Mobility Management Function (AMF) apparatus includes communicating with a second AMF apparatus. And the method includes receiving, from the second AMF apparatus directly, a Registration Request message of a User Equipment (UE) in CM-CONNECTED state.

In an aspect of the present disclosure, a method of a User Equipment (UE) includes communicating with a Radio Access Network (RAN). And the method includes sending, to the RAN, a Registration Request message of the UE in CM-CONNECTED state. The Registration Request message is sent by the RAN to a first Access and Mobility Management Function (AMF) apparatus, and the Registration Request message is sent by the first AMF apparatus to a second AMF apparatus directly.

In an aspect of the present disclosure, a first Access and Mobility Management Function (AMF) apparatus includes means for receiving, from a Radio Access Network (RAN), a Registration Request message of a User Equipment (UE) in CM-CONNECTED state. And the first AMF apparatus includes means for sending the Registration Request message to a second AMF apparatus directly.

In an aspect of the present disclosure, a first Access and Mobility Management Function (AMF) apparatus includes means for communicating with a second AMF apparatus. And the first AMF apparatus includes means for receiving, from the second AMF apparatus directly, a Registration Request message of a User Equipment (UE) in CM-CONNECTED state.

In an aspect of the present disclosure, a User Equipment (UE) includes means for communicating with a Radio Access Network (RAN). And the UE includes means for sending, to the RAN, a Registration Request message of the UE in CM-CONNECTED state. The Registration Request message is sent by the RAN to a first Access and Mobility Management Function (AMF) apparatus, and the Registration Request message is sent by the first AMF apparatus to a second AMF apparatus directly.

### BRIEF DESCRIPTION OF DRAWINGS

FIG. 1 illustrates Registration with AMF re-allocation procedure (forwarding via RAN).

FIG. 2 illustrates the structure of the Reroute NAS message.

FIG. 3 illustrates Registration with AMF re-allocation procedure (S-AMF to T-MF direct forwarding).

FIG. 4 illustrates System overview.

FIG. 5 is a block diagram for a User equipment (UE).

FIG. 6 is a block diagram for a (R)AN node.

FIG. 7 illustrates System overview of (R)AN node 5 based on O-RAN architecture.

FIG. 8 is a block diagram for a Radio Unit (RU).

FIG. 9 is a block diagram for a Distributed Unit (DU).

FIG. 10 is a block diagram for a Centralized Unit (CU).

FIG. 11 is a block diagram for an AMF.

FIG. 12 is a block diagram for a UDM.

FIG. 13 is a block diagram for a Network Slice Selection Function (NSSF).

FIG. 14 is a block diagram for a Network Repository Function (NRF).

FIG. 15 illustrates Registration with AMF re-allocation procedure.

FIG. 16 illustrates Reroute NAS request.

FIG. 17 illustrates Uplink NAS transport.

FIG. 18 illustrates the structure of the Uplink NAS Transport message.

FIG. 19 illustrates the structure of the Reroute NAS Request message.

### DESCRIPTION OF EMBODIMENTS

<Description of Disclosure with Aspects>

Each of aspects and elements included in the each aspects described below may be implemented independently or in combination with any other. These aspects include novel characteristics different from one another. Accordingly, these aspects contribute to achieving objects or solving problems different from one another and contribute to obtaining advantages different from one another.

### <Abbreviations>

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound
APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N5CW Non-5G-Capable over WLAN
NAI Network Access Identifier
NAS Non-Access Stratum
NEF Network Exposure Function
NF Network Function
NGAP Next Generation Application Protocol
NG-RAN Next Generation Radio Access Network
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAI Tracking Area Identity
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited PLMN
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended.

Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method.

Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

In this disclosure, a first access type may be 3GPP access and a second access type may be non-3GPP access respectively or vice versa.

### <First Aspect>

The first aspect solves a problem for a case where a serving AMF (or an S-AMF) re-allocates a new AMF (or a target AMF or a T-AMF) by re-routing a NAS message (e.g. a non-initial UE message) to the new AMF via an NG-RAN.

When the serving AMF receives a Registration Request message containing the Requested NSSAI for a UE in a CM-CONNECTED state, if the serving AMF does not support one or more S-NSSAIs from the Requested NSSAI, the serving AMF sends, to the NSSF, a message including the Requested NSSAI. The NSSF determines an AMF that can serve the one or more S-NSSAIs contained in the Requested NSSAI. The NSSF returns the Allowed NSSAI and a list of rejected S-NSSAI(s) and the address of a target AMF which can serve the S-NSSAI(s) contained in the Allowed NSSAI. In this case, the serving AMF re-routes the Registration Request message received from the UE to the NG-RAN in a first NGAP message (e.g. a Reroute NAS message). In the NGAP message to the NG-RAN the serving AMF includes the target AMF address (or the address of the target AMF), the Allowed NSSAI and the list of rejected S-NSSAI(s) and the security context of the UE. The NG-RAN, on receiving the first NGAP message, sends the Registration Request message in a second NGAP message (e.g. Uplink NAS Transport) to the target AMF. Upon receiving the Registration Request message, the target AMF proceeds with the registration procedure.

The detailed steps of the registration procedure with AMF re-allocation are as described below:

0. A UE is registered with a Serving AMF (or an S-AMF) for an S-NSSAI 1 over the first access type. A 5G-GUTI 1 is assigned to the UE by the S-AMF.

As there is active PDU session that is associated with the S-NSSAI 1, the UE is in CM-CONNECTED state. The CM-CONNECTED state may be called as CM-CONNECTED mode.

In one example, the UE and S-AMF have N1 signaling connection without any established PDU session or with an established PDU session without any data radio bearer (DRB) established.

1. The UE receives, for example from an application on the UE, a trigger to register to both the S-NSSAI 1 and S-NSSAI 2 while the UE is in CM-CONNECTED mode over the first access type. For example, the UE in the CM-CONNECTED mode performs registration procedure for registering to both a network slice indicated by the S-NSSAI 1 and a network slice indicated by S-NSSAI 2.

2. The UE sends a Registration Request message containing Requested NSSAI to the S-AMF. For example, the Requested NSSAI includes the S-NSSAI 1 and the S-NSSAI 2.

3. When the NG-RAN (or (R)AN or (R)AN node or NG-RAN node) receives the Registration Request message piggy-bagged in the UL information transfer message, the NG-RAN forwards the Registration Request message to the S-AMF by including the Registration Request message in the Uplink NAS Transport message. For example, the NG-RAN sends, to the S-AMF, the Uplink NAS Transport message including the Registration Request message. The Uplink NAS Transport message may be called as a non-initial UE message.

4a. The S-AMF sends, to NSSF, Nnssf_NSSelection_Get. The Nnssf_NSSelection_Get may be called as an Nnssf_NSSelection_Get message. For example, if the S-AMF does not support one or more S-NSSAIs included in the Requested NSSAI of the Registration Request message, the S-AMF sends the Nnssf_NSSelection_Get to the NSSF.

The Nnssf_NSSelection_Get includes the Requested NSSAI, NSSRG info (or information indicating NSSRG or NSSRG information), Mapping Of Requested NSSAI, Subscribed S-NSSAI(s) with the default S-NSSAI indication, TAI, Allowed NSSAI for the other access type (if any), Mapping of Allowed NSSAI, PLMN ID of the SUPI.

If there is a need for network slice selection, (see clause 5.15.5.2.1 of NPL 2), e.g. the S-AMF cannot serve all the S-NSSAI(s) from the Requested NSSAI permitted by the subscription information, the S-AMF invokes the Nnssf_NSSelection_Get service operation from the NSSF by including the Requested NSSAI, the NSSRG info, optionally Mapping Of Requested NSSAI, Subscribed S-NSSAIs with the default S-NSSAI indication, Allowed NSSAI for the other access type (if any), Mapping of Allowed NSSAI, PLMN ID of the SUPI and the TAI of the UE.

The S-AMF can also include the NSSRG (Network Slice Simultaneous Registration Group) affiliation information for each S-NSSAI from the Requested NSSAI by the UE. The NSSRG affiliation information may be called as NSSRG information. The S-AMF may have the NSSRG information stored in the UE context received from the old AMF (or another AMF) if the UE is requesting registration for mobility, or the S-AMF may retrieve the NSSRG information from the UDM if the UE is requesting initial registration.

In a case where one or more S-NSSAI(s) from the Requested NSSAI from the UE are subject to NSAC (Network Slice Admission Control) and there is no quota available for these S-NSSAI(s) (i.e. the number of the registered UEs with the S-NSSAI(s) has reached the allowed maximum), the S-AMF may pull that S-NSSAI(s) out from the Requested NSSAI in the Nnssf_NSSelection_Get message and the S-AMF treats that S-NSSAI(s) as Rejected S-NSSAI(s).

In a case where an S-NSSAI is subject to NSSAA and the NSSAA is revoked or NSSAA status is failed at the S-AMF then the S-AMF removes the S-NSSAI from the Requested NSSAI in the Nnssf_NSSelection_Get message i.e. the S-AMF does not send this S-NSSAI in the Requested NSSAI.

4b. The NSSF sends, to the S-AMF, a Response to Nnssf_NSSelection_Get. The response may be called as Nnssf_NSSelection_Get_Response. The response includes AMF Set or list of AMF addresses, Allowed NSSAI for the first access type, Mapping Of Allowed NSSAI, Allowed NSSAI for the second access type, Mapping of Allowed NSSAI, NSI ID(s), NRF(s), List of rejected S-NSSAI(s), rejected cause value(s), Configured NSSAI for the Serving PLMN, Mapping Of Configured NSSAI. The AMF Set may be target AMF (T-AMF) Set. The list of AMF addresses may be a list of T-AMF addresses.

The NSSF performs the steps specified in point (B) in clause 5.15.5.2.1 of NPL 2. The NSSF returns (or sends), to the serving AMF (i.e. the S-AMF), the Allowed NSSAI for the first access type, optionally the Mapping Of Allowed NSSAI, the Allowed NSSAI for the second access type (if any), optionally the Mapping of Allowed NSSAI and the target AMF (T-AMF) Set or, based on configuration, the list of candidate AMF(s) (e.g. the list of T-AMF(s)). The NSSF may return (or send), to the serving AMF (i.e. the S-AMF), NSI ID(s) associated to the Network Slice instance(s) corresponding to certain S-NSSAI(s). The NSSF may return (or send), to the serving AMF (i.e. the S-AMF), the NRF (s) to be used to select NFs/services within the selected Network Slice instance(s). The NSSF may also return (or send), to the serving AMF (i.e. the S-AMF), information regarding rejection causes for S-NSSAI(s) not included in the Allowed NSSAI. The NSSF may return (or send), to the serving AMF (i.e. the S-AMF), Configured NSSAI for the Serving PLMN, and possibly the associated mapping of the Configured NSSAI.

If the S-AMF included, in the Nnssf_NSSelection_Get, the NSSRG affiliation information for the S-NSSAI(s) from the Requested NSSAI, the NSSF may consider the provided NSSRG information when selecting the T-AMF (or target AMF) or the T-AMF set for the AMF re-allocation. For example, the S-AMF may select the T-AMF based on the NSSRG information.

5a. If the S-AMF does not locally store the target AMF (or the T-AMF) address, and if the S-AMF intends to use direct reroute to the target AMF (or the T-AMF) or the reroute via a (R)AN message needs to include AMF address, then the S-AMF invokes the Nnrf_NFDiscovery_Request service operation from the NRF to find a proper target AMF (or the T-AMF) which has required NF capabilities to serve the UE.

The NF type is set to AMF. The AMF Set is included in the Nnrf_NFDiscovery_Request. For example, the S-AMF sends the Nnrf_NFDiscovery_Request massage to the NRF.

5b. The NRF replies with the list of potential T-AMF(s). For example, the NRF sends, to the S-AMF, the Nnrf_NFDiscovery_Response message including the list of potential T-AMF(s). The NRF may also provide the details of the services offered by the candidate AMF(s) along with the notification end-point for each type of notification service that the selected AMF had registered with the NRF, if available. For example, the NRF sends, to the S-AMF, the Nnrf_NFDiscovery_Response message including the details of the services offered by the candidate AMF(s) along with the notification end-point for each type of notification service that the selected AMF had registered with the NRF. As an alternative, the NRF provides a list of potential T-AMFs and their capabilities, and optionally, additional selection rules.

For example, the NRF sends, to the S-AMF, the Nnrf_NFDiscovery_Response message including a list of potential T-AMFs and their capabilities, and optionally, additional selection rules. Based on the information about registered NFs and required capabilities, a T-AMF is selected by the S-AMF.

6. The S-AMF sends a Reroute NAS message to the (R)AN (or (R)AN node, NG-RAN or NG-RAN node). The Reroute NAS message may be called as a Re-Route NAS message. The Reroute NAS message includes at least the information about the T-AMF, Allowed NSSAI of the first access type, Allowed NSSAI of the second access type, NSSRG information, Rejected NSSAI, NAS security information for both first access type and second access type and the Uplink NAS transport message that contains the Registration Request message from the UE. The information about the T-AMF, Allowed NSSAI and Rejected NSSAI may be obtained at step 4b from the NSSF. The information about the T-AMF may include at least one of the AMF Set, the target AMF (the T-AMF) Set, the list of AMF addresses, and the list of T-AMF addresses. The Allowed NSSAI included in the Reroute NAS message may include S-NSSAI 2. The Rejected NSSAI included in the Reroute NAS message may include S-NSSAI 1.

In one example, the AMF changes Uplink NAS Transport message to an existing NGAP Message e.g. Initial UE Message or a new message containing the information elements being sent in the Uplink NAS Transport message and sends it in the Reroute NAS message to the NG-RAN.

The Registration Request message in the Uplink NAS transport message may be a one sent from the UE or the Registration Request message un-cyphered by the S-AMF.

The NSSRG information is related to the NSSRG affiliation of the S-NSSAI(s) in the Allowed NSSAI.

This NSSRG information is also forwarded to the T-AMF, so that the T-AMF can consider the NSSRG information when deciding the new or updated Allowed NSSAI for the UE in the T-AMF.

As some of the (R)AN may not have a capability for transferring the Uplink NAS Transport message to the T-AMF, the (R)AN may inform to the S-AMF about its capability of transferring the Uplink NAS Transport message by new capability indication set in the NG SETUP REQUEST message, RAN CONFIGURATION UPDATE message and AMF CONFIGURATION UPDATE ACKNOWLEDGE message. For example, the S-AMF may send the Reroute NAS message to the (R)AN in a case where the S-AMF receives, from the (R)AN, the capability indicating that the (R)AN supports transferring (or sending) the Uplink NAS Transport message to the T-AMF.

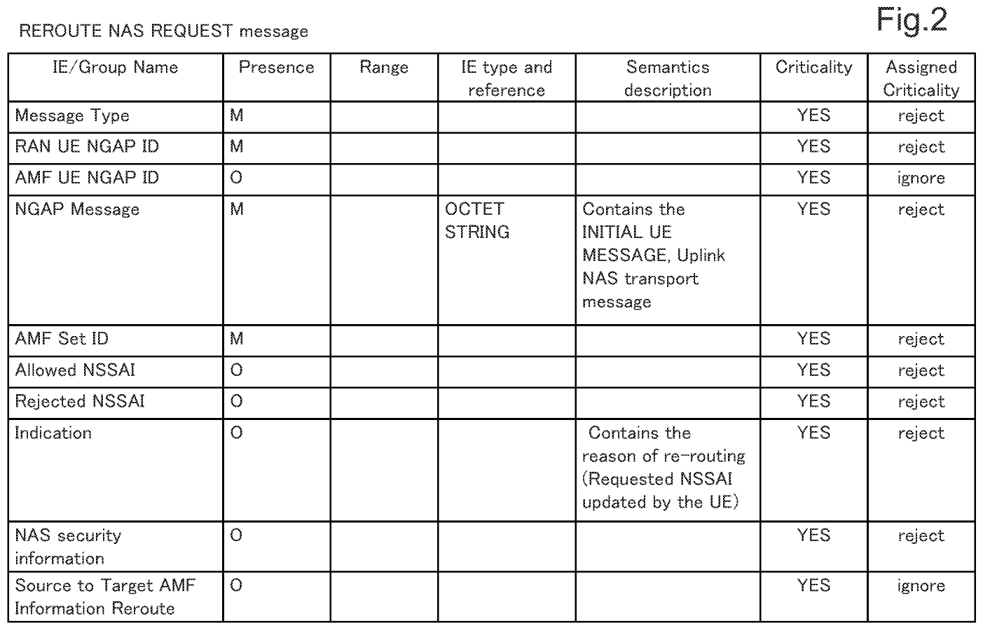

The FIG. 2 illustrates the structure of the Reroute NAS message as an example. In one example the Reroute NAS message may be an existing NGAP message or a new NGAP Message. The Reroute NAS message may be called as a REROUTE NAS REQUEST message.

7. The (R)AN sends the Uplink NAS Transport message to the T-AMF. For example, when the (R)AN receives the Reroute NAS message from the S-AMF, the (R)AN determines the T-AMF based on the information about the T-AMF (e.g. the address of the T-AMF), and sends the Uplink NAS Transport message to the T-AMF. The Uplink NAS Transport message includes at least one information elements sent in the Reroute NAS message, e.g. the Registration Request message, optionally the NAS security information of first access type or the second access type and an indication indicating that the Registration Request message from the UE is being rerouted due to Requested NSSAI is changed by the UE. For example, the Uplink NAS Transport message includes the NSSRG information.

If the Registration Request message received at step 6 from the S-AMF is the one un-cyphered by the S-AMF, the (R)AN includes the Registration Request message received at step 2 from the UE to the Uplink NAS Transport message instead of the one received from the S-AMF. The (R)AN may detect that the received Registration Request message from the S-AMF is not the same as the one received at step 2 by comparison.

In one example the Uplink NAS Transport message is an existing NGAP Message or a new NGAP message.

8. The T-AMF continues the Registration procedure from step 4 of section 4.2.2.2.2 in NPL 3 with the T-AMF corresponding to the new AMF.

### <Second Aspect>

The second aspect solves a problem for a case where the serving AMF re-allocates a new AMF by forwarding the NAS message (e.g. a non-initial UE message) to the target AMF directly.

When the serving AMF receives a Registration Request message containing the Requested NSSAI for a UE in a CM-CONNECTED state, if the serving AMF does not support one or more S-NSSAIs from the Requested NSSAI, the serving AMF sends, to the NSSF, a message including the Requested NSSAI. The NSSF determines an AMF that can serve the one or more S-NSSAIs contained in the Requested NSSAI. The NSSF returns the Allowed NSSAI and a list of rejected S-NSSAI(s) and the address of a target AMF which can serve the S-NSSAI(s) contained in the Allowed NSSAI. In this case, the serving AMF re-routes the Registration Request message received from the UE to the target AMF directly. Upon receiving the Registration Request message, the target AMF proceeds with the registration procedure.

The detailed steps of the registration procedure with AMF re-allocation are as described below:

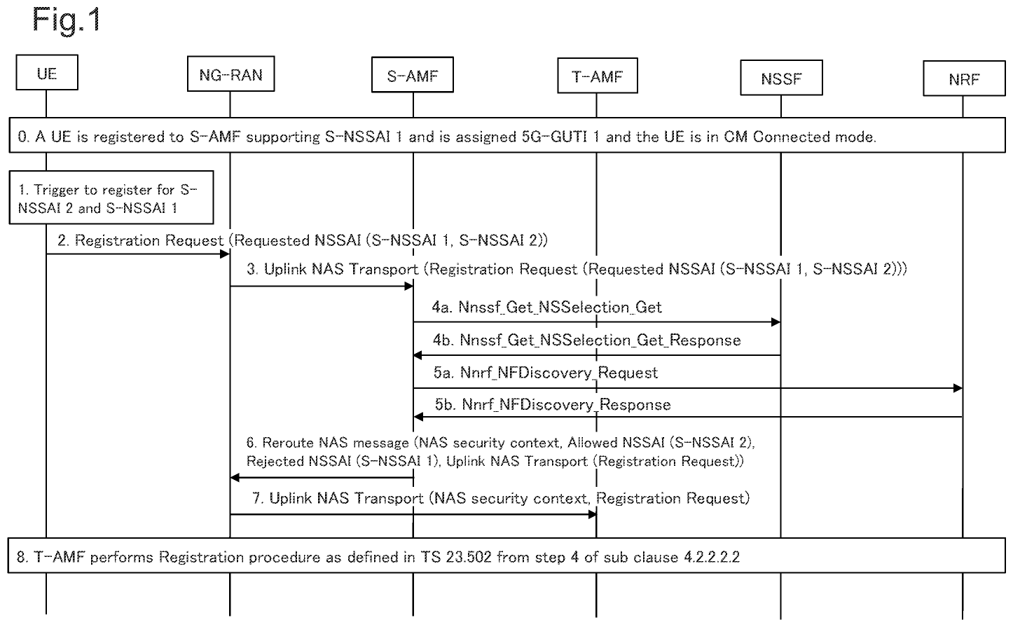

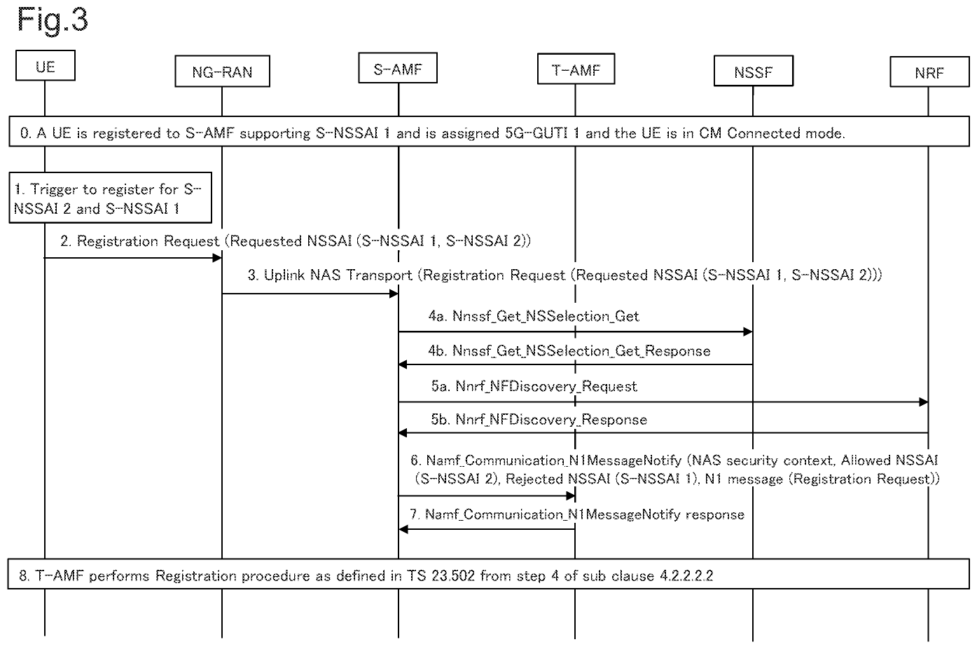

Steps 0 to 5b in the FIG. 3 are the same as steps 0 to 5b in the FIG. 1.

6. If the S-AMF, based on local policy and subscription information, decides to forward the NAS message (e.g. the Registration Request message received from the UE) to the target AMF (the T-AMF) directly, the S-AMF invokes the Namf_Communication_N1MessageNotify to the T-AMF, carrying the rerouted NAS message (e.g. the Registration Request message received from the UE).

For example, the S-AMF determines the T-AMF based on the information about the T-AMF (e.g. the address of the T-AMF), and invokes the Namf_Communication_N1MessageNotify to the T-AMF. For example, the S-AMF sends the Namf_Communication_N1MessageNotify to the T-AMF.

The Namf_Communication_N1MessageNotify service operation (or the Namf_Communication_N1MessageNotify) includes the information enabling (R)AN to identify the N2 terminating point, and the full Registration Request message (e.g. the Registration Request message received from the UE), and the UE's SUPI and MM Context if available. If the initial AMF (i.e. S-AMF) has obtained the information from the NSSF as described at step 4b, that information except the AMF Set or list of AMF addresses is included in the Namf_Communication_N1MessageNotify. The Namf_Communication_N1MessageNotify may be called as a Namf_Communication_N1MessageNotify message.

In addition, the Namf_Communication_N1MessageNotify may include Allowed NSSAI of the first access type, Allowed NSSAI of the second access type, NSSRG information, Rejected NSSAI, NAS security information for both first access type and second access type.

The NSSRG information is related to the NSSRG affiliation of the S-NSSAI(s) in the Allowed NSSAI.

This NSSRG information is also forwarded to the T-AMF, so that the T-AMF can consider the NSSRG information when deciding the new or updated Allowed NSSAI for the UE in the T-AMF.

The target AMF (the T-AMF) then updates the (R)AN with a new updated N2 termination point for the UE in the first message from target AMF (T-AMF) to (R)AN in step 8.

7. The T-AMF sends the Namf_Communication_N1MessageNotify response message to the S-AMF.

For example, when the T-AMF receives the Namf_Communication_N1MessageNotify message, the T-AMF sends the Namf_Communication_N1MessageNotify response message to the S-AMF.

Step 8 in the FIG. 3 is the same as step 8 in the FIG. 1.

### <System Overview>

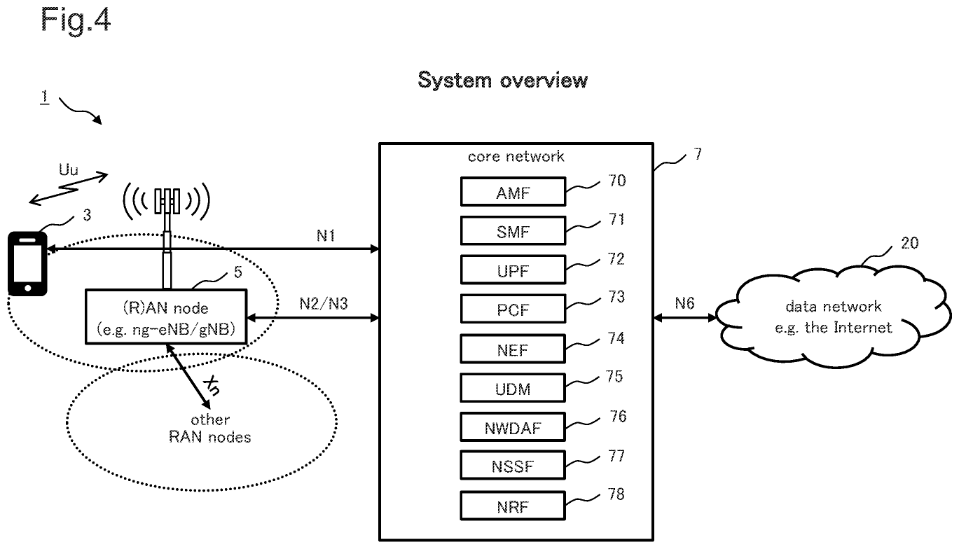

FIG. 4 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Data Analytics Function (NWDAF) 76, a Network Slice Selection Function (NSSF) 77 and a Network Repository Function (NRF) 78. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection. The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC Setup Complete message: This message is sent from the UE 3 to the (R)AN node 5. In addition to the parameters that are disclosed by Aspects in this disclosure, following parameters may be included together in the RRC Setup Complete message.
guami-Type, iab-NodeIndication, idleMeas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, following parameters may be included together in the Registration Request message.
5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, following parameters may be included together in the Registration Accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

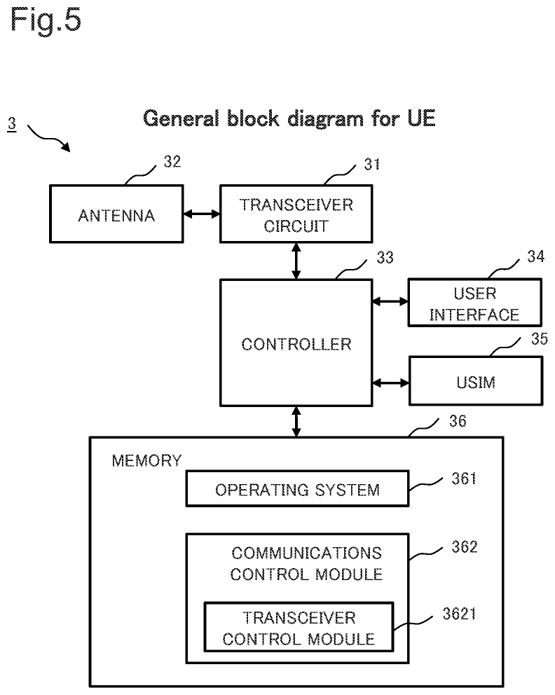

FIG. 5 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate.

Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines: turbines: solar panels: wind turbines; hydroelectric generators: thermal power generators: nuclear electricity generators: batteries; nuclear systems and/or associated equipment: heavy electrical machinery: pumps including vacuum pumps: compressors: fans: blowers: oil hydraulic equipment; pneumatic equipment: metal working machinery: manipulators; robots and/or their application systems: tools: molds or dies; rolls: conveying equipment: elevating equipment: materials handling equipment: textile machinery: sewing machines: printing and/or related machinery: paper converting machinery: chemical machinery: mining and/or construction machinery and/or related equipment: machinery and/or implements for agriculture, forestry and/or fisheries: safety and/or environment preservation equipment: tractors: precision bearings: chains: gears: power transmission equipment: lubricating equipment: valves: pipe fittings: and/or application systems for any of the previously mentioned equipment or machinery etc.).

The UE 3 may, for example, be an item of transport equipment (for example transport equipment such as: rolling stocks: motor vehicles: motor cycles: bicycles: trains; buses; carts: rickshaws: ships and other watercraft; aircraft: rockets: satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

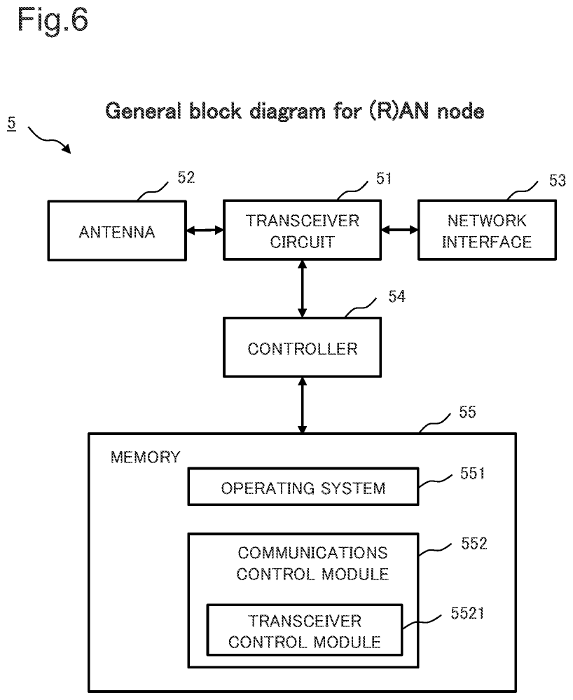

FIG. 6 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimates and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

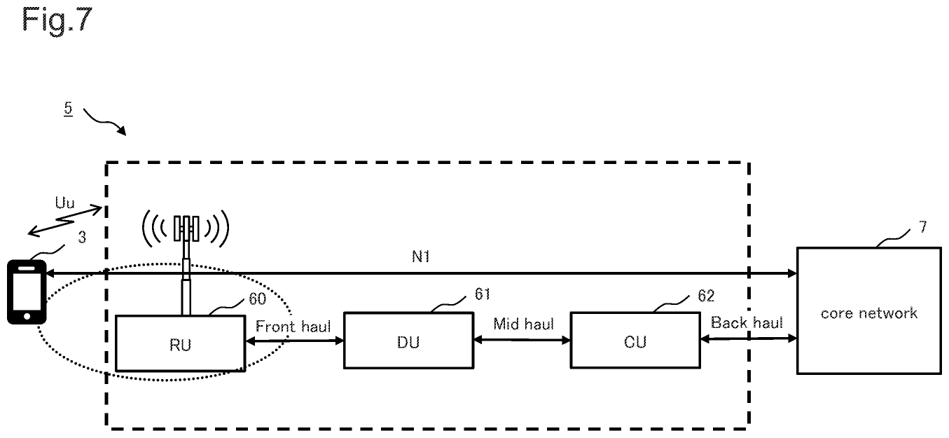

FIG. 7 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5.

Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

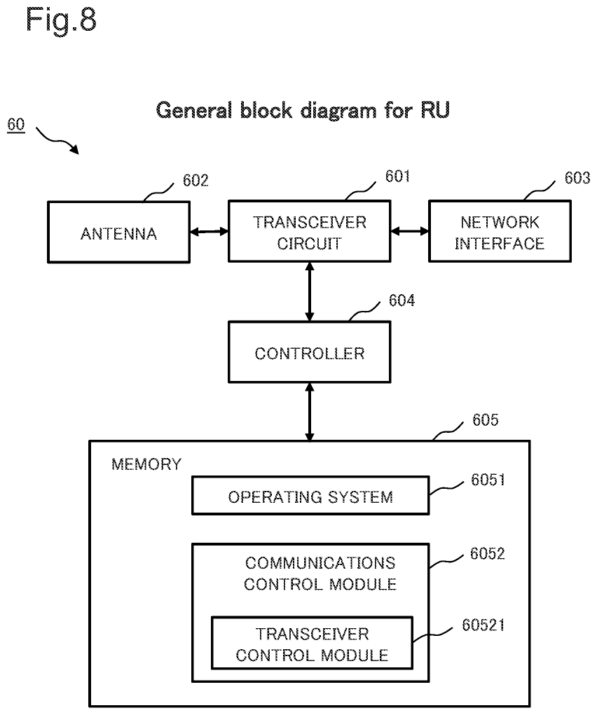

FIG. 8 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimates and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

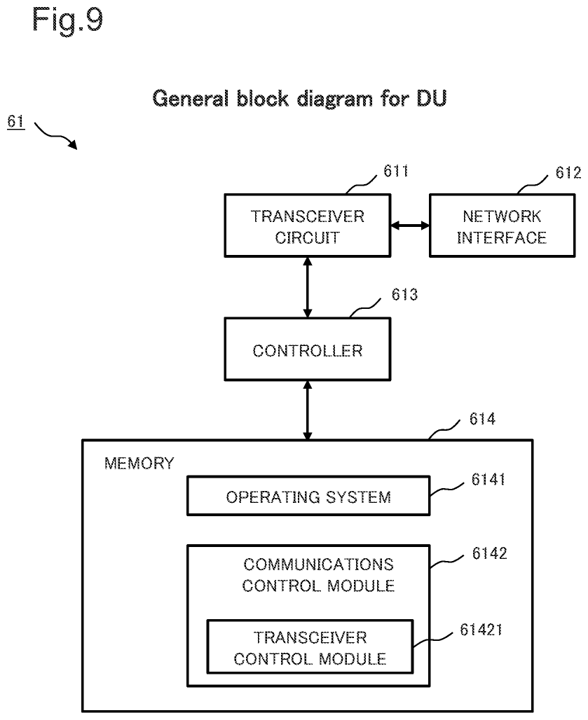

FIG. 9 is a block diagram illustrating the main components of an exemplary DU 61, for example a DU part of a base station (‘eNB’ in LTE, ‘gNB’ in 5G, a base station for 5G beyond, a base station for 6G).

As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614.

Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

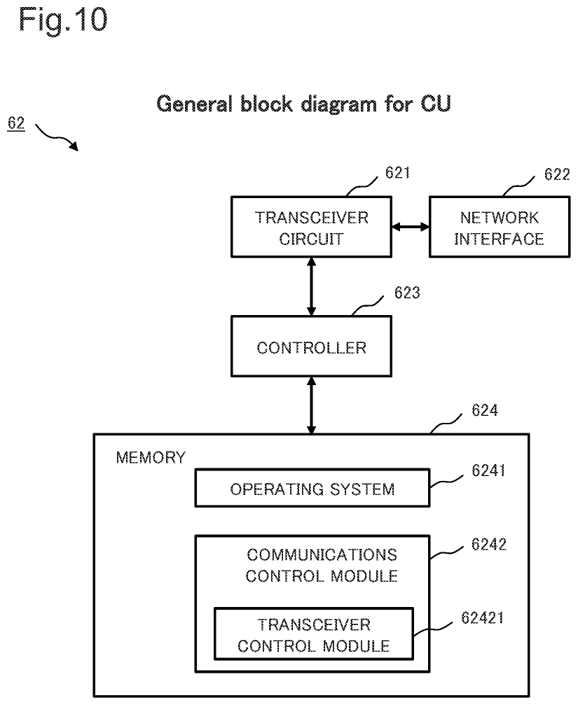

FIG. 10 is a block diagram illustrating the main components of an exemplary CU 62, for example a CU part of base station (′eNB′ in LTE, ‘gNB’ in 5G, a base station for 5G beyond, a base station for 6G).

As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624.

Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

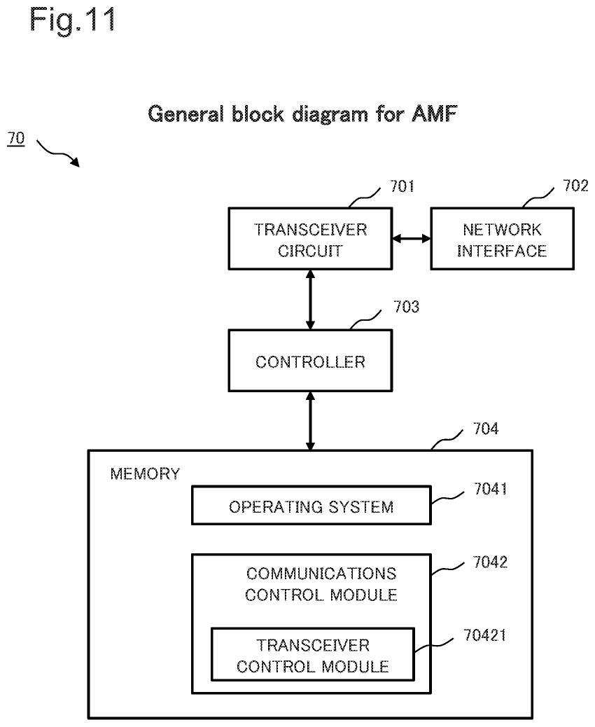

FIG. 11 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421.

The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <UDM>

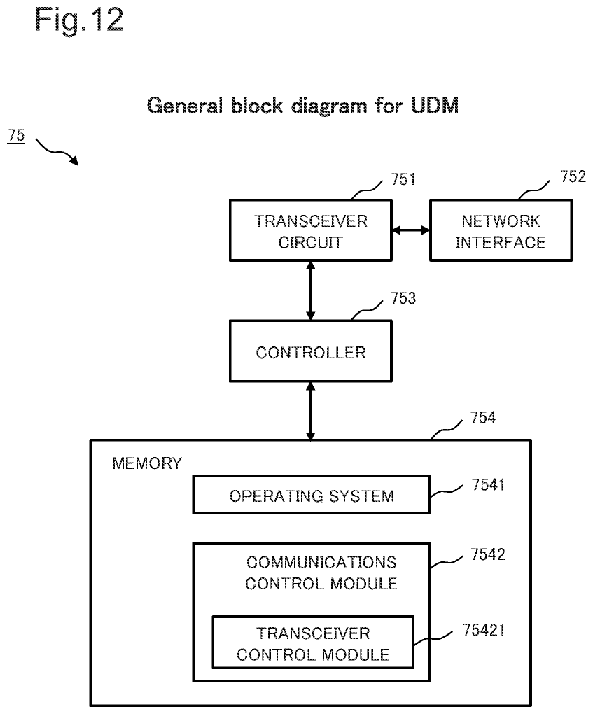

FIG. 12 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NSSF>

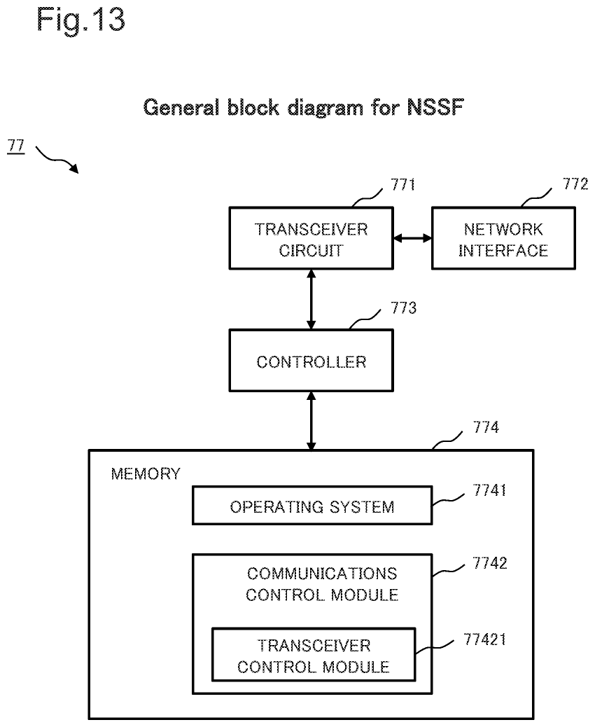

FIG. 13 is a block diagram illustrating the main components of the NSSF 77. As shown, the apparatus includes a transceiver circuit 771 which is operable to transmit signals to and to receive signals from other nodes (including the AMF 70) via a network interface 772. A controller 773 controls the operation of the NSSF 77 in accordance with the software stored in a memory 774. The Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSSF 77 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NSSF 77 may support the Non-Public Network (NPN), The NPN may be a Stand-alone Non-Public Network (SNPN) or a Public Network Integrated NPN (PNI-NPN).

### <NRF>

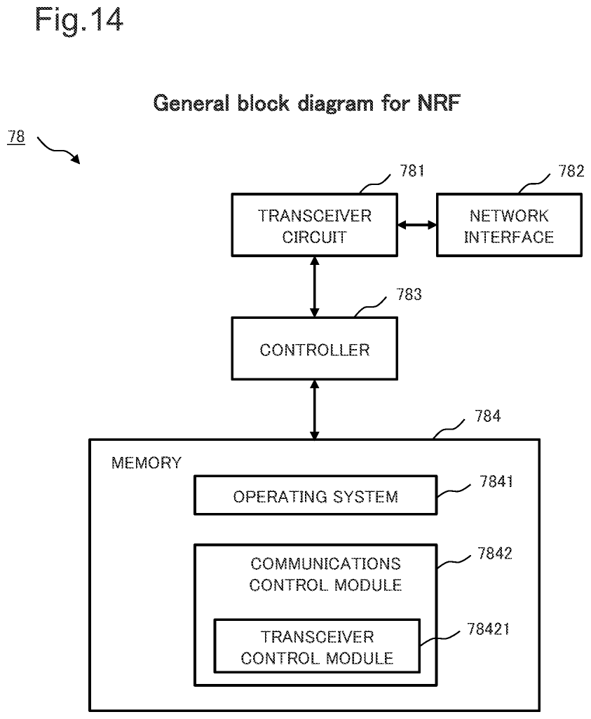

FIG. 14 is a block diagram illustrating the main components of the NRF 78. As shown, the apparatus includes a transceiver circuit 781 which is operable to transmit signals to and to receive signals from other nodes (including the AMF 70) via a network interface 782. A controller 783 controls the operation of the NRF 78 in accordance with the software stored in a memory 784. The Software may be pre-installed in the memory 784 and/or may be downloaded via the telecommunication network or from a removable data storage device (RMD), for example. The software includes, among other things, an operating system 7841 and a communications control module 7842 having at least a transceiver control module 78421. The communications control module 7842 (using its transceiver control module 78421 is responsible for handling (generating/sending/receiving) signalling between the NRF 78 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NRF 78 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs): input/output (IO) circuits; internal memories/caches (program and/or data): processing registers; communication buses (e.g. control, data and/or address buses); direct memory access (DMA) functions: hardware or software implemented counters, pointers and/or timers: and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description, but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS.

According to this disclosure, the disclosure defines a Registration procedure with AMF re-allocation procedure when the UE is in CM-CONNECTED state.

For example, the disclosure can solve a problem that it is not clear in current 3GPP specifications how a non-initial UE message (e.g. an Uplink NAS Transport message, or an Uplink NAS Transport message including a Registration Request message) can be transferred from the initial AMF to the target AMF when the initial AMF decided to re-allocate AMF for the UE.

For example, this disclosure defines how a non-initial UE message can be transferred from the initial AMF to the target AMF when the initial AMF decided to re-allocate the AMF for the UE. For example, the disclosure can solve a problem that some of the Registration Management procedure does not work and leads to service degradation for the mobile users.

The whole or part of the Aspects disclosed above can be described as, but not limited to, the following.

<4.2.2.2.3 Registration with AMF Re-Allocation>

When an AMF receives a Registration request, the AMF may need to reroute the Registration request to another AMF, e.g. when the initial AMF is not the appropriate AMF to serve the UE. The Registration with AMF re-allocation procedure, described in FIG. 4.2.2.2.3-1, is used to reroute the NAS message of the UE to the target AMF during a Registration procedure. This procedure may be triggered in both the UE is in CM-IDLE state or CM-CONNECTED state.

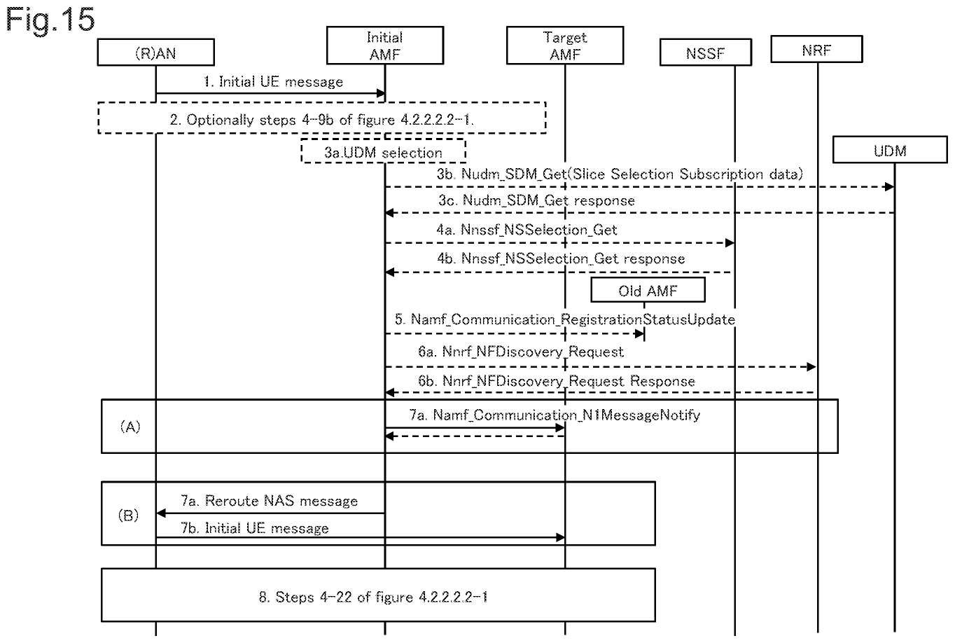

FIG. 4.2.2.2.3-1: Registration with AMF Re-Allocation Procedure (See FIG. 15 of the Present Application.)

The initial AMF and the target AMF register their capability at the NRF.

1. Steps 1 and 2 of FIG. 4.2.2.2.2-1 have occurred, and the (R)AN sends the Registration request message within an Initial UE message to the initial AMF if the UE is in CM-IDLE state. The (R)AN sends the Registration request message within a UPLINK NAS TRANSPORT message to the initial AMF If the UE is in CM-CONNECTED state.

2. If the AMF needs the SUPI and/or UE's subscription information to decide whether to reroute the Registration Request or if the Registration Request was not sent integrity protected or integrity protection is indicated as failed, then AMF performs steps 4 to 9a or to 9b of FIG. 4.2.2.2.2-1.

3a. [Conditional] If the initial AMF needs UE's subscription information to decide whether to reroute the Registration Request and UE's slice selection subscription information was not provided by old AMF, the AMF selects a UDM as described in TS 23.501 [2], clause 6.3.8.

3b. Initial AMF to UDM: Nudm_SDM_Get (SUPI, Slice Selection Subscription data).

The initial AMF request UE's Slice Selection Subscription data from UDM by invoking the Nudm_SDM_Get (see clause 5.2.3.3.1) service operation. UDM may get this information from UDR by Nudr_DM_Query (SUPI, Slice Selection Subscription data).

3c. UDM to initial AMF: Response to Nudm_SDM_Get. The AMF gets the Slice Selection Subscription data including Subscribed S-NSSAIs.

UDM responds with slice selection data to initial AMF.

4a. [Conditional] Initial AMF to NSSF: Nnssf_NSSelection_Get (Requested NSSAI, [Mapping Of Requested NSSAI], Subscribed S-NSSAI(s) with the default S-NSSAI indication, TAI, Allowed NSSAI for the other access type (if any), [Mapping of Allowed NSSAI], PLMN ID of the SUPI).

If there is a need for slice selection, (see clause 5.15.5.2.1 of TS 23.501 [2]), e.g. the initial AMF cannot serve all the S-NSSAI(s) from the Requested NSSAI permitted by the subscription information, the initial AMF invokes the Nnssf_NSSelection_Get service operation from the NSSF by including Requested NSSAI, optionally Mapping Of Requested NSSAI, Subscribed S-NSSAIs with the default S-NSSAI indication, Allowed NSSAI for the other access type (if any), Mapping of Allowed NSSAI, PLMN ID of the SUPI and the TAI of the UE.

4b. [Conditional] NSSF to Initial AMF: Response to Nnssf_NSSelection_Get (AMF Set or list of AMF addresses, Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s))], [Configured NSSAI for the Serving PLMN], [Mapping Of Configured NSSAI]).

The NSSF performs the steps specified in point (B) in clause 5.15.5.2.1 of TS 23.501 [2]. The NSSF returns to initial AMF the Allowed NSSAI for the first access type, optionally the Mapping Of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s). It may return also information regarding rejection causes for S-NSSAI(s) not included in the Allowed NSSAI. The NSSF may return Configured NSSAI for the Serving PLMN, and possibly the associated mapping of the Configured NSSAI.

NOTE 1: The NRF (s) returned by the NSSF, if any, belong to any level of NRF (see clause 6.2.6 of TS 23.501 [2]) according to the deployment decision of the operator.

5. [Conditional] Initial AMF to old AMF: Namf_Communication_RegistrationStatus Update (failure cause).

If another AMF is selected, the initial AMF sends a reject indication to the old AMF telling that the UE Registration procedure did not fully complete at the initial AMF. The old AMF continues as if the Namf_Communication_UEContextTransfer had never been received.

6a. [Conditional] Initial AMF to NRF: Nnrf_NFDiscovery_Request (NF type, AMF Set).

If the initial AMF does not locally store the target AMF address, and if the initial AMF intends to use direct reroute to target AMF or the reroute via (NG-R)AN message needs to include AMF address, then the initial AMF invokes the Nnrf_NFDiscovery_Request service operation from the NRF to find a proper target AMF which has required NF capabilities to serve the UE. The NF type is set to AMF. The AMF Set is included in the Nnrf_NFDiscovery_Request.

6b. [Conditional] NRF to AMF: Response to Nnrf_NFDiscovery_Request (list of (AMF pointer, AMF address, plus additional selection rules and NF capabilities)).

The NRF replies with the list of potential target AMF (s). The NRF may also provide the details of the services offered by the candidate AMF(s) along with the notification end-point for each type of notification service that the selected AMF had registered with the NRF, if available. As an alternative, it provides a list of potential target AMFs and their capabilities, and optionally, additional selection rules.

Based on the information about registered NFs and required capabilities, a target AMF is selected by the initial AMF.

If the security association has been established between the UE and initial AMF, to avoid a registration failure, the initial AMF shall forward the NAS message to the target AMF by executing step 7 (A).

NOTE 2: The security context in the initial AMF is not transferred to the target AMF if initial AMF forward the NAS message to the target AMF via (R)AN. In this case the UE rejects the NAS message sent from target AMF as the security context in the UE and target AMF are not synchronized.

NOTE 3: Network slice isolation cannot be completely maintained in case the AMF reallocation is executed by step 7(A).

If the initial AMF is not part of the target AMF Set, and is not able to get a list of candidate AMF(s) by querying the NRF with the target AMF Set (e.g. the NRF locally pre-configured on AMF does not provide the requested information, the query to the appropriate NRF provided by the NSSF is not successful, or the initial AMF has knowledge that the initial AMF is not authorized as serving AMF etc.) then the initial AMF shall forward the NAS message to the target AMF via (R)AN executing step 7(B) unless the security association has been established between the UE and initial AMF; the Allowed NSSAI and the AMF Set are included to enable the (R)AN to select the target AMF as described in TS 23.501 [2] clause 6.3.5.

7(A). If the initial AMF, based on local policy and subscription information, decides to forward the NAS message to the target AMF directly, the initial AMF invokes the Namf_Communication_N1MessageNotify to the target AMF, carrying the rerouted NAS message. The Namf_Communication_N1MessageNotify service operation includes the information enabling (R)AN to identify the N2 terminating point, and the Registration Request message received from the UE, and the UE's SUPI and MM Context if available. If the initial AMF has obtained the information from the NSSF as described at step 4b, that information except the AMF Set or list of AMF addresses is included. The target AMF then updates the (R)AN with a new updated N2 termination point for the UE in the first message from target AMF to RAN in step 8.

7(B). If the initial AMF, based on local policy and subscription information, decides to forward the NAS message to the target AMF via (R)AN unless the target AMF(s) are returned from the NSSF and identified by a list of candidate AMF (s), the initial AMF sends a Reroute NAS message to the (R)AN (step 7a). The Reroute NAS message includes the information about the target AMF, Allowed NSSAI of the first access type, Allowed NSSAI of the second source type, Source to target AMF information reroute, NAS security context, and the Registration Request message received from the UE. If the initial AMF has obtained the information as described at step 4b, that information is included. The (R)AN sends the Initial UE message or the Uplink NAS Transport message to the target AMF (step 7b) indicating reroute due to slicing including the information from step 4b that the NSSF provided. The Uplink NAS transport message contains Allowed NSSAI of the first access type, Allowed NSSAI for the second access type, Source to Target information reroute, NAS security context of the first access type and the NAS security context of the second access type.

8. After receiving the Registration Request message transmitted at step 7(A)a or step 7(B)b, the target AMF continues with the Registration procedure from step 4 until 22 of FIG. 4.2.2.2.2-1 (with the target AMF corresponding to the new AMF), which includes the UE context retrieved from old AMF. If the 5G security context is received from the initial AMF, the target AMF continue using that one instead of the 5G security context retrieved from old AMF. If the initial AMF decides to forward the NAS message to the target AMF (step 7(A), the first message from the target AMF to (R)AN (either Initial Context Setup Request, or Downlink NAS Transport) contain the AMF name of the initial AMF and target AMF UE NGAP ID.

### <8.6.5 Reroute NAS Request>

### <8.6.5.1 General>

The purpose of the Reroute NAS Request procedure is to enable the AMF to request for a rerouting of the INITIAL UE MESSAGE message or the UPLINK NAS TRANSPORT message to another AMF.

### <8.6.5.2 Successful Operation>

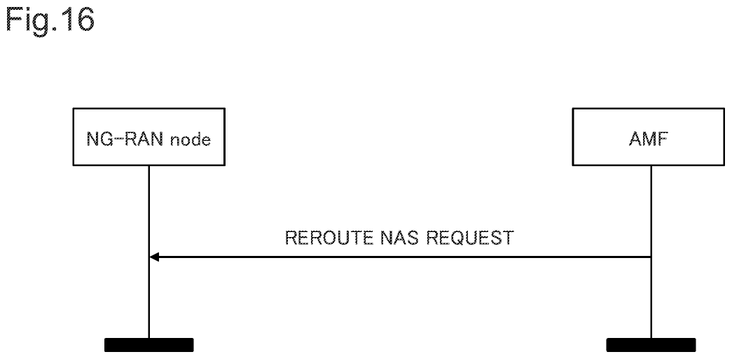

### FIG. 8.6.5.2-1: Reroute NAS Request (See FIG. 16 of the Present Application.)

The AMF initiates the procedure by sending a REROUTE NAS REQUEST message to the NG-RAN node. The NG-RAN node shall, if supported, reroute the INITIAL UE MESSAGE message or the UPLINK NAS TRANSPORT message to an AMF indicated by the AMF Set ID IE as described in TS 23.501 [9].

If the Allowed NSSAI IE is included in the REROUTE NAS REQUEST message, then the NG-RAN node shall propagate it in the rerouted INITIAL UE MESSAGE message or the UPLINK NAS TRANSPORT message as defined in TS 23.502 [10].

If the Source to Target AMF Information Reroute IE is included in the REROUTE NAS REQUEST message or the UPLINK NAS TRANSPORT message, then the NG-RAN node shall propagate it in the rerouted INITIAL UE MESSAGE message as defined in TS 23.502 [10].

### <8.6.3 Uplink NAS Transport>

### <8.6.3.1 General>

The Uplink NAS Transport procedure is used when the NG-RAN node has received from the radio interface a NAS message to be forwarded to the AMF to which a UE-associated logical NG-connection for the UE exists or the Serving AMF is rerouting the UPLINK NAS TRANSPORT Message to the target AMF during the AMF reallocation in case when UE associated logical NG-connection exists for the UE with the serving AMF but the UPLINK NAS TRANSPORT message is rerouted to the target AMF.

### <8.6.3.2 Successful Operation>

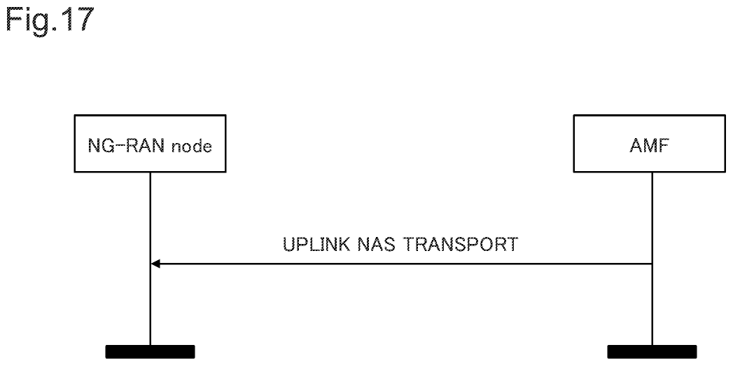

### FIG. 8.6.3.2-1: Uplink NAS Transport (See FIG. 17 of the Present Application.)

The NG-RAN node initiates the procedure by sending an UPLINK NAS TRANSPORT message to the AMF.

The NAS-PDU IE contains a UE & #8211; AMF message that is transferred without interpretation in the NG-RAN node.

If the Allowed NSSAI IE is included in the REROUTE NAS REQUEST message, then the NG-RAN node shall propagate it in the rerouted INITIAL UE MESSAGE message or UPLINK NAS

TRANSPORT message as defined in TS 23.502 [10].

If the Source to Target AMF Information Reroute IE is included in the REROUTE NAS REQUEST message, the NG-RAN node shall propagate it in the rerouted INITIAL UE MESSAGE or UPLINK NAS TRANSPORT message defined in TS 23.502 [10].

If the NAS security context IE is included in the REROUTE NAS REQUEST message, the NG-RAN shall propagate it in the UPLINK NAS TRANSPORT Message.

### <9.2.5.3 Uplink NAS Transport>

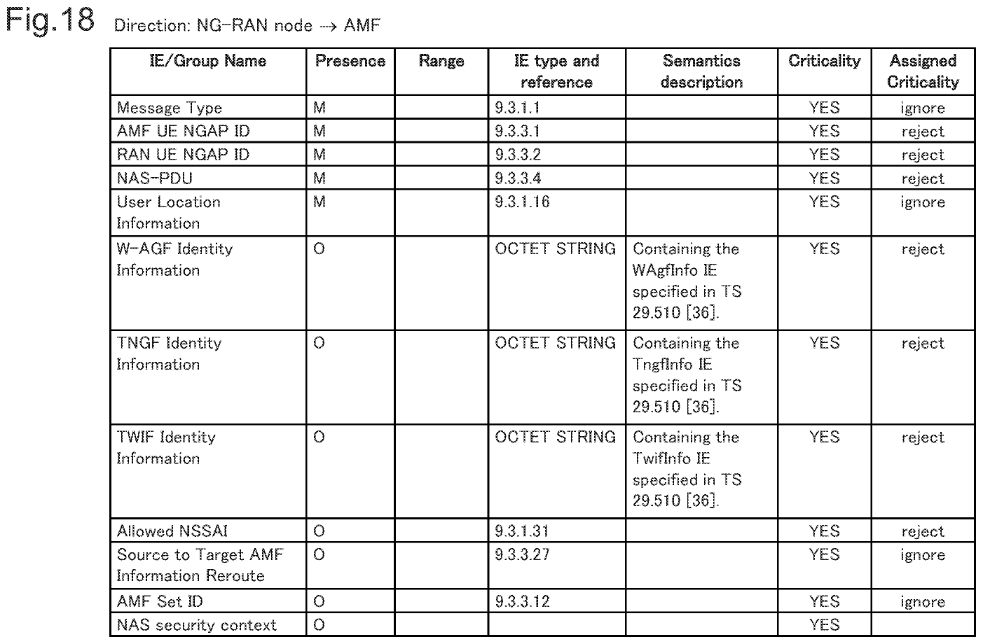

This message is sent by the NG-RAN node and is used for carrying NAS information over the NG interface. (See FIG. 18 of the present application.)

### <9.2.5.5 Reroute NAS Request>

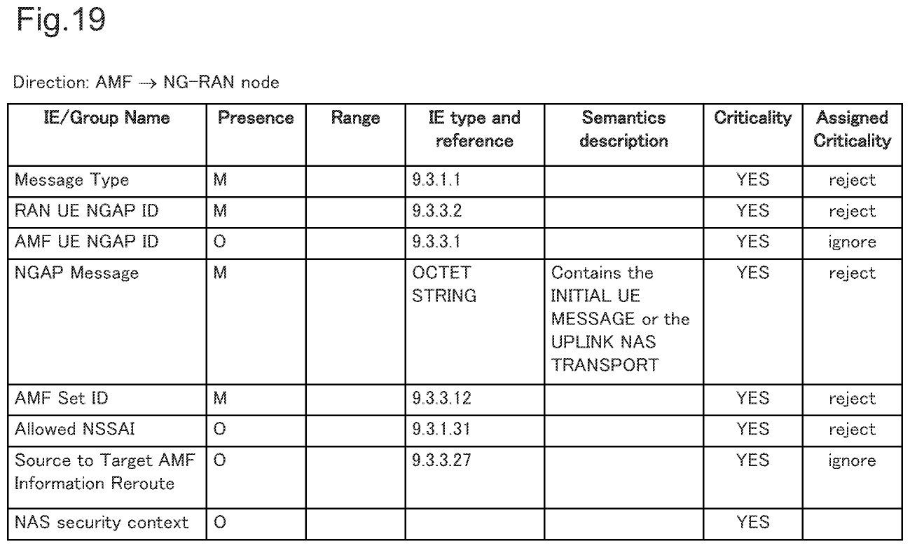

This message is sent by the AMF in order to request for a rerouting of the INITIAL UE MESSAGE to another AMF. (See FIG. 19 of the present application.)

The whole or part of the example Aspects disclosed above can be described as, but not limited to, the following supplementary notes.

### <First Supplementary Notes>

### Supplementary Note 1.

A method of a first Access and Mobility Management Function (AMF) apparatus comprising:
receiving, from a User Equipment (UE) in CM-CONNECTED mode, a Registration Request message; and
sending the Registration Request message to a second AMF apparatus via a Radio Access Network (RAN) node.

### Supplementary Note 2.

The method according to supplementary note 1,
wherein the Registration Request message received from the UE is included in a Uplink Non-Access Stratum (NAS) Transport message.

### Supplementary Note 3.

The method according to supplementary note 1 or 2,
wherein the Registration Request message sent to the second AMF apparatus is included in a Reroute NAS message.

### Supplementary Note 4.

A method of a Radio Access Network (RAN) node comprising:
receiving, from a User Equipment (UE) in CM-CONNECTED mode, a Registration Request message;
sending a first Uplink Non-Access Stratum (NAS) Transport message to a first Access and Mobility Management Function (AMF) apparatus,
wherein the first Uplink NAS Transport message includes the Registration Request message received from the UE;
receiving a Reroute NAS message from the first AMF apparatus,
wherein the Reroute NAS message includes the Registration Request message received from the UE; and sending a second Uplink NAS Transport message to a second AMF apparatus,
wherein the second Uplink NAS Transport message includes the Registration Request message received from the UE.

### Supplementary Note 5.

A method of a first Access and Mobility Management Function (AMF) apparatus comprising:
receiving, from a User Equipment (UE) in CM-CONNECTED mode, a Registration Request message; and
sending the Registration Request message to a second AMF apparatus.

### Supplementary Note 6.

The method according to supplementary note 5,
wherein the Registration Request message received from the UE is included in a Uplink Non-Access Stratum (NAS) Transport message.

### Supplementary Note 7.

The method according to supplementary note 5 or 6,
wherein the Registration Request message sent to the second AMF apparatus is included in Namf_Communication_N1MessageNotify.

### Supplementary Note 8.

A method of a first Access and Mobility Management Function (AMF) apparatus comprising:
communicating with a second AMF apparatus; and
receiving, from the second AMF apparatus, a Registration Request message related to a User Equipment (UE) in CM-CONNECTED mode.

### Supplementary Note 9.

A first Access and Mobility Management Function (AMF) apparatus comprising:
means for receiving, from a User Equipment (UE) in CM-CONNECTED mode, a Registration Request message; and
means for sending the Registration Request message to a second AMF apparatus via a Radio Access Network (RAN) node.

### Supplementary Note 10.

The first AMF apparatus according to supplementary note 9,
wherein the Registration Request message received from the UE is included in a Uplink Non-Access Stratum (NAS) Transport message.

### Supplementary Note 11.

The first AMF apparatus according to supplementary note 9 or 10,
wherein the Registration Request message sent to the second AMF apparatus is included in a Reroute NAS message.

### Supplementary Note 12.

A Radio Access Network (RAN) node comprising:
means for receiving, from a User Equipment (UE) in CM-CONNECTED mode, a Registration Request message;
means for sending a first Uplink Non-Access Stratum (NAS) Transport message to a first Access and Mobility Management Function (AMF) apparatus,
wherein the first Uplink NAS Transport message includes the Registration Request message received from the UE;
means for receiving a Reroute NAS message from the first AMF apparatus,
wherein the Reroute NAS message includes the Registration Request message received from the UE; and
means for sending a second Uplink NAS Transport message to a second AMF apparatus,
wherein the second Uplink NAS Transport message includes the Registration Request message received from the UE.

### Supplementary Note 13.

A first Access and Mobility Management Function (AMF) apparatus comprising:
means for receiving, from a User Equipment (UE) in CM-CONNECTED mode, a Registration Request message; and
means for sending the Registration Request message to a second AMF apparatus.

### Supplementary Note 14.

The first AMF according to supplementary note 13,
wherein the Registration Request message received from the UE is included in a Uplink Non-Access Stratum (NAS) Transport message.

### Supplementary Note 15.

The first AMF according to supplementary note 13 or 14,
wherein the Registration Request message sent to the second AMF apparatus is included in Namf_Communication_N1MessageNotify.

### Supplementary Note 16.

A first Access and Mobility Management Function (AMF) apparatus comprising:
means for communicating with a second AMF apparatus; and
means for receiving, from the second AMF apparatus, a Registration Request message related to a User Equipment (UE) in CM-CONNECTED mode.

### <Second Supplementary Notes>

### Supplementary Note 1.

A method of a first Access and Mobility Management Function (AMF) apparatus, the method comprising:
receiving, from a Radio Access Network (RAN), a Registration Request message of a User Equipment (UE) in CM-CONNECTED state; and
sending the Registration Request message to a second AMF apparatus directly.

### Supplementary Note 2.

The method according to supplementary note 1,
wherein the Registration Request message received from the RAN is included in an Uplink Non-Access Stratum (NAS) Transport message.

### Supplementary Note 3.

The method according to supplementary note 1 or 2,
wherein the Registration Request message sent to the second AMF apparatus is included in Namf_Communication_N1MessageNotify.

### Supplementary Note 4.

The method according to any one of supplementary notes 1 to 3,
wherein the Registration Request message is sent by the UE to the RAN.

### Supplementary Note 5.

The method according to any one of supplementary notes 1 to 4,
wherein a Registration procedure is continued by the second AMF apparatus after receiving the Registration Request message.

### Supplementary Note 6.

The method according to supplementary note 5,
wherein a Registration Accept message is sent by the second AMF apparatus to the UE in the Registration procedure.

### Supplementary Note 7.

The method according to any one of supplementary notes 1 to 6,
wherein the Registration Request message sent to the second AMF apparatus is in clear text.

### Supplementary Note 8.

A method of a first Access and Mobility Management Function (AMF) apparatus, the method comprising:
communicating with a second AMF apparatus; and
receiving, from the second AMF apparatus directly, a Registration Request message of a User Equipment (UE) in CM-CONNECTED state.

### Supplementary Note 9.

The method according to supplementary note 8,
wherein the Registration Request message received from the second AMF apparatus is included in Namf_Communication_N1MessageNotify.

### Supplementary Note 10.

The method according to supplementary note 8 or 9,
wherein the Registration Request is sent by a Radio Access Network (RAN) to the second AMF apparatus.

### Supplementary Note 11.

The method according to supplementary note 10,
wherein the Registration Request message sent by the RAN to the second AMF apparatus is included in an Uplink Non-Access Stratum (NAS) Transport message.

### Supplementary Note 12.

The method according to supplementary note 10 or 11,
wherein the Registration Request message is sent by the UE to the RAN.

### Supplementary Note 13.

The method according to any one of supplementary notes 8 to 12, further comprising:
continuing a Registration procedure after receiving the Registration Request message.

### Supplementary Note 14.

The method according to supplementary note 13, further comprising:
sending, to the UE, a Registration Accept message in the Registration procedure.

### Supplementary Note 15.

The method according to any one of supplementary notes 8 to 14,
wherein the Registration Request message received from the second AMF apparatus is in clear text.

### Supplementary Note 16.

A method of a User Equipment (UE), the method comprising:
communicating with a Radio Access Network (RAN); and
sending, to the RAN, a Registration Request message of the UE in CM-CONNECTED state,
wherein the Registration Request message is sent by the RAN to a first Access and Mobility Management Function (AMF) apparatus, and the Registration Request message is sent by the first AMF apparatus to a second AMF apparatus directly.

### Supplementary Note 17.

The method according to supplementary note 16, further comprising:
receiving, from the second AMF apparatus, a Registration Accept message including a 5G-GUTI and an Allowed NSSAI.

### Supplementary Note 18.

The method according to supplementary note 16 or 17,
wherein the Registration Request message sent by the RAN to the first AMF apparatus is included in an Uplink Non-Access Stratum (NAS) Transport message.

### Supplementary Note 19.

The method according to any one of supplementary notes 16 to 18,
wherein the Registration Request message sent by the first AMF apparatus to the second AMF apparatus is included in Namf_Communication_N1MessageNotify.

### Supplementary Note 20.

The method according to any one of supplementary notes 16 to 19,
wherein a Registration procedure is continued by the second AMF apparatus after receiving the Registration Request message.

### Supplementary Note 21.

The method according to supplementary notes 20, further comprising:
receiving, from the second AMF apparatus, a Registration Accept message in the Registration procedure.

### Supplementary Note 22.

The method according to any one of supplementary notes 16 to 21,
wherein the Registration Request message sent by the first AMF apparatus to the second AMF apparatus is in clear text.

### Supplementary Note 23.

A first Access and Mobility Management Function (AMF) apparatus comprising:
means for receiving, from a Radio Access Network (RAN), a Registration Request message of a User Equipment (UE) in CM-CONNECTED state; and
means for sending the Registration Request message to a second AMF apparatus directly.

### Supplementary Note 24.

The first AMF apparatus according to supplementary note 23,
wherein the Registration Request message received from the RAN is included in an Uplink Non-Access Stratum (NAS) Transport message.

### Supplementary Note 25.

The first AMF apparatus according to supplementary note 23 or 24,
wherein the Registration Request message sent to the second AMF apparatus is included in Namf_Communication_N1MessageNotify.

### Supplementary Note 26.

The first AMF apparatus according to any one of supplementary notes 23 to 25,
wherein the Registration Request message is sent by the UE to the RAN.

### Supplementary Note 27.

The first AMF apparatus according to any one of supplementary notes 23 to 26,
wherein a Registration procedure is continued by the second AMF apparatus after receiving the Registration Request message.

### Supplementary Note 28.

The first AMF apparatus according to supplementary note 27,
wherein a Registration Accept message is sent by the second AMF apparatus to the UE in the Registration procedure.

### Supplementary Note 29.

The first AMF apparatus according to any one of supplementary notes 23 to 28,
wherein the Registration Request message sent to the second AMF apparatus is in clear text.

### Supplementary Note 30.

A first Access and Mobility Management Function (AMF) apparatus comprising:
means for communicating with a second AMF apparatus; and
means for receiving, from the second AMF apparatus directly, a Registration Request message of a User Equipment (UE) in CM-CONNECTED state.

### Supplementary Note 31.

The first AMF apparatus according to supplementary note 30,
wherein the Registration Request message received from the second AMF apparatus is included in Namf_Communication_N1MessageNotify.

### Supplementary Note 32.

The first AMF apparatus according to supplementary note 30 or 31,
wherein the Registration Request is sent by a Radio Access Network (RAN) to the second AMF apparatus.

### Supplementary Note 33.

The first AMF apparatus according to supplementary note 32,
wherein the Registration Request message sent by the RAN to the second AMF apparatus is included in an Uplink Non-Access Stratum (NAS) Transport message.

### Supplementary Note 34.

The first AMF apparatus according to supplementary note 32 or 33,
wherein the Registration Request message is sent by the UE to the RAN.

### Supplementary Note 35.

The first AMF apparatus according to any one of supplementary notes 30 to 34, further comprising:
means for continuing a Registration procedure after receiving the Registration Request message.

### Supplementary Note 36.

The first AMF apparatus according to supplementary note 35, further comprising:
means for sending, to the UE, a Registration Accept message in the Registration procedure.

### Supplementary Note 37.

The first AMF apparatus according to any one of supplementary notes 30 to 36,
wherein the Registration Request message received from the second AMF apparatus is in clear text.

### Supplementary Note 38.

A User Equipment (UE) comprising:
means for communicating with a Radio Access Network (RAN); and
means for sending, to the RAN, a Registration Request message of the UE in CM-CONNECTED state,
wherein the Registration Request message is sent by the RAN to a first Access and Mobility Management Function (AMF) apparatus, and the Registration Request message is sent by the first AMF apparatus to a second AMF apparatus directly.

### Supplementary Note 39.

The UE according to supplementary note 38, further comprising:
means for receiving, from the second AMF apparatus, a Registration Accept message including a 5G-GUTI and an Allowed NSSAI.

### Supplementary Note 40.

The UE according to supplementary note 38 or 39,
wherein the Registration Request message sent by the RAN to the first AMF apparatus is included in an Uplink Non-Access Stratum (NAS) Transport message.

### Supplementary Note 41.

The UE according to any one of supplementary notes 38 to 40,
wherein the Registration Request message sent by the first AMF apparatus to the second AMF apparatus is included in Namf_Communication_N1 MessageNotify.

### Supplementary Note 42.

The UE according to any one of supplementary notes 38 to 41,
wherein a Registration procedure is continued by the second AMF apparatus after receiving the Registration Request message.

### Supplementary Note 43

The UE according to supplementary notes 42, further comprising:
means for receiving, from the second AMF apparatus, a Registration Accept message in the Registration procedure.

### Supplementary Note 44.

The UE according to any one of supplementary notes 38 to 43,
wherein the Registration Request message sent by the first AMF apparatus to the second AMF apparatus is in clear text.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111028660, filed on Jun. 25, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 NSSF
78 NRF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
751 transceiver circuit
752 network interface
753 controller
754 memory
771 transceiver circuit
772 network interface
773 controller
774 memory
781 transceiver circuit
782 network interface
783 controller
784 memory
3621 transceiver control module
5521 transceiver control module
6051 operating system
6052 communications control module
6141 operating system
6142 communications control module
6241 operating system
6242 communications control module
7041 operating system
7042 communications control module
7541 operating system
7542 communications control module
7741 operating system
7742 communications control module
7841 operating system
7842 communications control module
60521 transceiver control module
61421 transceiver control module
62421 transceiver control module
70421 transceiver control module
75421 transceiver control module
77421 transceiver control module
78421 transceiver control module

What is claimed is:

1. A method of a first Access and Mobility Management Function (AMF) apparatus, the method comprising:
receiving, from a Radio Access Network (RAN), a Registration Request message of a User Equipment (UE) in CM-CONNECTED state; and
sending the Registration Request message to a second AMF apparatus directly,
wherein the Registration Request message sent to the second AMF apparatus is in clear text.

2. The method according to claim 1,
wherein the Registration Request message received from the RAN is included in an Uplink Non-Access Stratum (NAS) Transport message.

3. The method according to claim 1, wherein the Registration Request message sent to the second AMF apparatus is included in Namf_Communication_N1MessageNotify.

4. The method according to claim 1,
wherein the Registration Request message is sent by the UE to the RAN.

5. The method according to claim 1,
wherein a Registration procedure is continued by the second AMF apparatus after receiving the Registration Request message.

6. The method according to claim 5,
wherein a Registration Accept message is sent by the second AMF apparatus to the UE in the Registration procedure.

7. (canceled)

8. A method of a first Access and Mobility Management Function (AMF) apparatus, the method comprising:
communicating with a second AMF apparatus; and
receiving, from the second AMF apparatus directly, a Registration Request message of a User Equipment (UE) in CM-CONNECTED state,
wherein the Registration Request message received from the second AMF apparatus is in clear text.

9. The method according to claim 8,
wherein the Registration Request message received from the second AMF apparatus is included in Namf_Communication_N1MessageNotify.

10. The method according to claim 8,
wherein the Registration Request message is sent by a Radio Access Network (RAN) to the second AMF apparatus.

11. The method according to claim 10,
wherein the Registration Request message sent by the RAN to the second AMF apparatus is included in an Uplink Non-Access Stratum (NAS) Transport message.

12. The method according to claim 10, wherein the Registration Request message is sent by the UE to the RAN.

13. The method according to claim 8, further comprising:
continuing a Registration procedure after receiving the Registration Request message.

14. The method according to claim 13, further comprising:
sending, to the UE, a Registration Accept message in the Registration procedure.

15. (canceled)

16. A method of a User Equipment (UE), the method comprising:
communicating with a Radio Access Network (RAN); and
sending, to the RAN, a Registration Request message of the UE in CM-CONNECTED state,
wherein the Registration Request message is sent by the RAN to a first Access and Mobility Management Function (AMF) apparatus, and the Registration Request message is sent by the first AMF apparatus to a second AMF apparatus directly, and
wherein the Registration Request message sent by the first AMF apparatus to the second AMF apparatus is in clear text.

17. The method according to claim 16, further comprising:
receiving, from the second AMF apparatus, a Registration Accept message including a 5G-GUTI and an Allowed NSSAI.

18. The method according to claim 16, wherein the Registration Request message sent by the RAN to the first AMF apparatus is included in an Uplink Non-Access Stratum (NAS) Transport message.

19. The method according to claim 16,
wherein the Registration Request message sent by the first AMF apparatus to the second AMF apparatus is included in Namf_Communication_N1MessageNotify.

20. The method according to claim 16,
wherein a Registration procedure is continued by the second AMF apparatus after receiving the Registration Request message.

21. The method according to claim 20, further comprising:
receiving, from the second AMF apparatus, a Registration Accept message in the Registration procedure.

22. (canceled)

23. A first Access and Mobility Management Function (AMF) apparatus comprising one or more memories storing instructions and one or more processors configured to execute the instructions to:
receive, from a Radio Access Network (RAN), a Registration Request message of a User Equipment (UE) in CM-CONNECTED state; and
send the Registration Request message to a second AMF apparatus directly,
wherein the Registration Request message sent to the second AMF apparatus is in clear text.

24. The first AMF apparatus according to claim 23,
wherein the Registration Request message received from the RAN is included in an Uplink Non-Access Stratum (NAS) Transport message.

25. The first AMF apparatus according to claim 23,
wherein the Registration Request message sent to the second AMF apparatus is included in Namf_Communication_N1MessageNotify.

26. The first AMF apparatus according to claim 23,
wherein the Registration Request message is sent by the UE to the RAN.

27. The first AMF apparatus according to claim 23,
wherein a Registration procedure is continued by the second AMF apparatus after receiving the Registration Request message.

28. The first AMF apparatus according to claim 27,
wherein a Registration Accept message is sent by the second AMF apparatus to the UE in the Registration procedure.

29. (canceled)

30. A first Access and Mobility Management Function (AMF) apparatus comprising one or more memories storing instructions and one or more processors configured to execute the instructions to:
communicate with a second AMF apparatus; and
receive, from the second AMF apparatus directly, a Registration Request message of a User Equipment (UE) in CM-CONNECTED state,
wherein the Registration Request message received from the second AMF apparatus is in clear text.

31. The first AMF apparatus according to claim 30,
wherein the Registration Request message received from the second AMF apparatus is included in Namf_Communication_N1MessageNotify.

32. The first AMF apparatus according to claim 30,
wherein the Registration Request message is sent by a Radio Access Network (RAN) to the second AMF apparatus.

33. The first AMF apparatus according to claim 32,
wherein the Registration Request message sent by the RAN to the second AMF apparatus is included in an Uplink Non-Access Stratum (NAS) Transport message.

34. The first AMF apparatus according to claim 32,
wherein the Registration Request message is sent by the UE to the RAN.

35. The first AMF apparatus according to claim 30,
wherein the one or more processors are configured to execute the instructions to continue a Registration procedure after receiving the Registration Request message.

36. The first AMF apparatus according to claim 35,
wherein the one or more processors are configured to execute the instructions to send, to the UE, a Registration Accept message in the Registration procedure.

37. (canceled)

38. A User Equipment (UE) comprising one or more memories storing instructions and one or more processors configured to execute the instructions to:
communicate with a Radio Access Network (RAN); and
send, to the RAN, a Registration Request message of the UE in CM-CONNECTED state,
wherein the Registration Request message is sent by the RAN to a first Access and Mobility Management Function (AMF) apparatus, and the Registration Request message is sent by the first AMF apparatus to a second AMF apparatus directly, and
wherein the Registration Request message sent by the first AMF apparatus to the second AMF apparatus is in clear text.

39. The UE according to claim 38, wherein the one or more processors are configured to execute the instructions to receive, from the second AMF apparatus, a Registration Accept message including a 5G-GUTI and an Allowed NSSAI.

40. The UE according to claim 38, wherein the Registration Request message sent by the RAN to the first AMF apparatus is included in an Uplink Non-Access Stratum (NAS) Transport message.

41. The UE according to, claim 38,
wherein the Registration Request message sent by the first AMF apparatus to the second AMF apparatus is included in Namf_Communication_N1MessageNotify.

42. The UE according to claim 38,
wherein a Registration procedure is continued by the second AMF apparatus after receiving the Registration Request message.

43. The UE according to claim 42, wherein the one or more processors are configured to execute the instructions to receive, from the second AMF apparatus, a Registration Accept message in the Registration procedure.

44. (canceled)
